(19) United States
(12) Patent Application Publication
(10) Pub. No.: US 2025/0229218 A1
(43) Pub. Date: Jul. 17, 2025

(54) Carbon Capturing Plant

(71) Applicants: Satish KUMAR, Purtjab (IN); Anupreet KUMAR, Punjab (IN)

(72) Inventor: Satish KUMAR, Purtjab (IN)

(21) Appl. No.: 18/699,120

(22) PCT Filed: Aug. 10, 2022
(86) PCT No.: PCT/IB2022/057455

§ 371 Date: Apr. 5, 2024

(30) Foreign Application Priority Data
Oct. 6, 2021 (IN) 202111045492

(51) Int. Cl. B01D 53/14; B01D 47/02; B01D 53/18

(52) U.S. Cl. CPC B01D 53/1475; B01D 47/02; B01D 53/1493; B01D 53/185; B01D 2252/103; B01D 2257/504; B01D 2258/0283

(57) ABSTRACT

The present disclosure relates to an apparatus (100) for treatment of harmful gas, the apparatus comprising a first chamber (104-1) filled with a first filtering element (112-1) to filter out a first set of contaminants from the gas. A first filter (106-1) coupled to the first chamber (104- to filter the gas received from the first chamber. A second chamber (104-2) filled with a second filtering element (106-2) to filter out a second set of contaminants from the gas. A second filter (106-2) coupled to the second chamber (104-2) and adapted to filter the gas received from the second chamber. A third chamber (104-3) filled with a liquid to allow filtered gas from the second filter (106-2) to flow through the liquid and a third filter to filter the liquid from the gas, wherein the filtered air from the third chamber is released to the environment.

### TECHNICAL FIELD

The present disclosure relates, in general, a means for treating polluted gases, and more specifically, relates to a carbon-capturing plant.

### BACKGROUND

Air pollution is caused by the discharge into the air of gases and materials such as carbon dioxide, hydrocarbons, sulphur dioxide, nitrogen dioxide, carbon monoxide, soot, dust, and chemicals associated with the combustion process. Automobiles contribute approximately 40% of the pollutants released into the air per day. However, the remaining 60% of air pollutants, which are mainly attributable to boilers, furnaces, incinerators, and manufacturing processes, can be reduced. These pollutant sources are all fixed-base, i.e., stationary. By removing or filtering the pollutants from these stationary sources, much can be done to reduce air pollution.

Carbon dioxide (CO2) is one of the so-called greenhouse gases, which cause climate change. Most of the carbon dioxide emissions are caused by the combustion of fossil fuels. Since CO2 is identified as the main greenhouse gas, its capture and storage are essential to control global warming. CO2 emissions are mainly produced by fossil fuel power generation plants and some heavy industries. 50% of the worldwide energy supply is provided by coal power plants, 40% by oil and approximately 25% by natural gas, all of which are pumping CO2 gas into the atmosphere through their exhaust.

On the other hand, there are several usages of carbon dioxide, for example, used in improving oil pumping and in the food industry. Removal and recovery of carbon dioxide from flue gases is therefore not only advantageous for the protection of the environment but also enables the commercial utilization of the recovered carbon dioxide. During the combustion of fossil fuels, gaseous waste products including carbon dioxide, carbon monoxide and nitrous oxides are produced. These waste products generate air pollution and are known to be greenhouse gases that contribute to climate change.

In the combustion of a fuel, such as coal, oil, peat, waste, etc., in a combustion plant, such as a power plant, a hot process gas is generated, such process gas containing, among other components, carbon dioxide. With increasing environmental demands various processes for removing carbon dioxide from the process gas have been developed. To meet the air pollution control requirement and to maintain levels of air quality, the concentration of air contaminants due to all sources should not exceed the standards established by the environmental regulations. Therefore, to reduce the level of air contaminants emitted, polluting industries, hospitals, incinerators, electricity-generating installations or the like should possess air pollution control equipment to eliminate, prevent, reduce, control or regulate the emission of specified air contaminants into the atmosphere.

There is a therefore a need in the art to provide a simple and cost-effective means that enable the capturing of polluted gases and sequesters generation of CO2 in the atmosphere.

### OBJECTS OF THE PRESENT DISCLOSURE

An object of the present disclosure relates, in general, a means for treating polluted gases, and more specifically, relates to a carbon-capturing plant.

Another object of the present disclosure is to provide an apparatus that treats polluted gases.

Another object of the present disclosure is to provide an apparatus that removes particulate matter and reduces harmful gases from a stream of polluted gases produced by fabrication or combustion processes found in many industries.

Another object of the present disclosure is to provide an apparatus that reduces air pollution.

Another object of the present disclosure is to provide an apparatus that is economical, durable in use, and efficient in operation.

Another object of the present disclosure is to provide an apparatus that is highly efficient, economical, stable, and has a long service life.

Yet another object of the present disclosure provides an apparatus that can be available at an affordable cost and require less maintenance.

### BRIEF DESCRIPTION OF THE DRAWINGS

In the figures, similar components and/or features may have the same reference label. Further, various components of the same type may be distinguished by following the reference label with a second label that distinguishes among the similar components. If only the first reference label is used in the specification, the description is applicable to any one of the similar components having the same first reference label irrespective of the second reference label.

FIG. 1 illustrates an exemplary representation of an apparatus for treating harmful gases, in accordance with an embodiment of the present disclosure.

FIG. 2 illustrates an exemplary representation of a source coupled to the apparatus, in accordance with an embodiment of the present disclosure.

### SUMMARY

The present disclosure relates, in general, a means for treating polluted gases, and more specifically, relates to a carbon-capturing plant. The present disclosure relates to an apparatus that can include three chambers, where the first chamber is partially filled with an emulsion. An exhaust pipe of source containing smoke, gases (CO2) is coupled to the bottom of the first chamber such that the gas passes through the emulsion filled in the first chamber. In this process, the smoke is filtered while passing through the emulsion. The gas is again filtered by a first filter located on top of the first chamber and the gas is passed to a second chamber, where the gas is again filtered in this process. A spray gun is fitted in the second chamber to produce mist of the same solution of detergent and water mix up with gas or wash the gas to filter it. The gas is filtered again by a second filter located at the top of the second chamber. Finally, the gas is passed through the water in a third chamber, after which the gas is filtered by a third filter located on top of the third chamber to remove water from the air. After the filtration process, harmful gases or greenhouse gases are fully converted to clean air.

In an aspect, the present disclosure provides an apparatus for treatment of harmful gas, the apparatus comprising a first chamber partially filled with a first filtering element and coupled to an exhaust pipe of a source, the first chamber adapted to allow gas from the exhaust pipe to flow through the first filtering element, wherein the first filtering element is adapted to filter out a first set of contaminants from the gas, a first filter coupled to the first chamber and adapted to filter the gas received from the first chamber, a second chamber filled with a second filtering element and coupled to the first filter, the second chamber adapted to allow filtered gas from the first filter to flow through the second filtering element, wherein the second filtering element is adapted to filter out a second set of contaminants from the gas, a second filter coupled to the second chamber adapted to filter the gas received from the second chamber, a third chamber filled with a liquid and coupled to the second filter, the third chamber adapted to allow filtered gas from the second filter to flow through the liquid; and a third filter coupled to the third chamber adapted to filter the liquid from the gas, wherein based on the filtration process, the contaminates from the gas is removed and converted into clean air that is released to the environment.

According to an embodiment, the first filtering element can be an emulsion of water, oil and detergent.

According to an embodiment, the exhaust pipe of the source is coupled to the bottom of the first chamber.

According to an embodiment, the first set of contaminants and the second set of contaminates comprise any or a combination of smoke particles and harmful substances in the exhaust gas.

According to an embodiment, the first filter is arranged at the top of the first chamber, the first filter conveys the filtered gases from the first chamber to the bottom of the second chamber.

According to an embodiment, the second filtering element is a detergent mixed water.

According to an embodiment, the second filter is arranged at the top of the second chamber, the second filter conveys the filtered gases from the second chamber to the bottom of the third chamber.

According to an embodiment, the liquid can be is water.

According to an embodiment, a spray gun is coupled to second chamber, the spray gun operable to produce mist of detergent and water to filter the received gases.

According to an embodiment, the gases comprise carbon dioxide, particulates and any combination thereof.

Various objects, features, aspects, and advantages of the inventive subject matter will become more apparent from the following detailed description of preferred embodiments, along with the accompanying drawing figures in which like numerals represent like components.

### DETAILED DESCRIPTION

The following is a detailed description of embodiments of the disclosure depicted in the accompanying drawings. The embodiments are in such detail as to clearly communicate the disclosure. If the specification states a component or feature “may”, “can”, “could”, or “might” be included or have a characteristic, that particular component or feature is not required to be included or have the characteristic.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The present disclosure relates, in general, a means for treating polluted gases, and more specifically, relates to a carbon-capturing plant. The present disclosure relates to an apparatus that can include three chambers, where the first chamber is partially filled with an emulsion. An exhaust pipe of source containing smoke, gases (CO2) is coupled to the bottom of the first chamber such that the gas passes through the emulsion filled in the first chamber. In this process, the smoke is filtered while passing through the emulsion. The gas is again filtered by a first filter located on top of the first chamber and the gas is passed to a second chamber, where the gas is again filtered in this process A spray gun is fitted in the second chamber to produce mist of the same solution of detergent and water mix up with gas or wash the gas to filter it. The gas is filtered again by a second filter located at the top of the second chamber. Finally, the gas is passed through the water in a third chamber, after which the gas is filtered by a third filter located on top of the third chamber to remove water from the air. After the filtration process, harmful gases or greenhouse gases are fully converted to clean air. The present disclosure can be described in enabling detail in the following examples, which may represent more than one embodiment of the present disclosure.

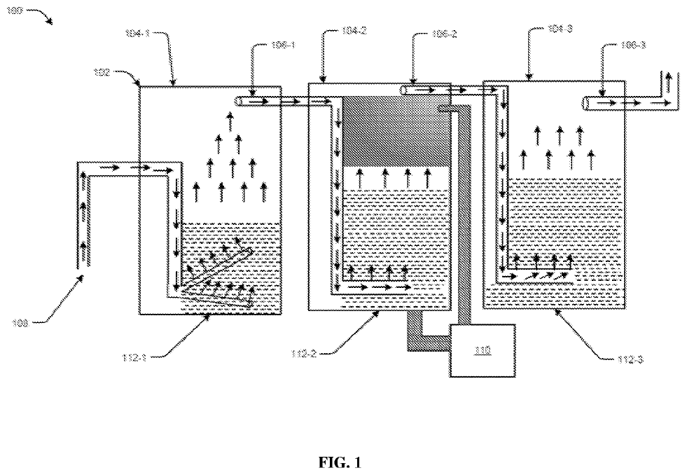

FIG. 1 illustrates an exemplary representation of an apparatus for treating harmful gases, in accordance with an embodiment of the present disclosure.

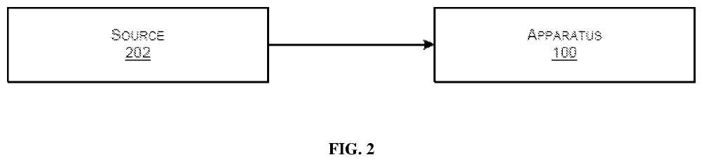

Referring to FIG. 1, apparatus 100 is configured to treat, purify harmful gases that are generated by a source 202 (as illustrated in FIG. 2) to reduce the number of particles in the gases or smoke and the volume of harmful gases before they are emitted into the environment. The harmful gas includes greenhouse gases such as carbon dioxide, natural gas and any combination thereof. The harmful gas may be generated by the source such as chimneys, factories, hospitals or other industries. The apparatus 100 can include a housing 102, one or more chambers (104-1 to 104-3) configured in housing 102, one or more filters (106-1 to 106-3) coupled to the one or more chambers (104-1 to 104-3) and one or more filtering elements (112-1 to 112-3) may partially fill the one or more chambers (104-1 to 104-3).

The apparatus 100 can include housing 102 of suitable configuration. One or more chambers (104-1 to 104-3) are configured in housing 102 of the apparatus 100. In an exemplary embodiment, one or more chambers (104-1 to 104-3) as presented in the example can include three chambers. As can be appreciated, the present disclosure may not be limited to this configuration but may be extended to other configurations. The one or more chambers (104-1 to 104-3) can include a first chamber 104-1, a second chamber 104-2 and a third chamber 104-3, where these one or more chambers (104-1 to 104-3) may be arranged in series in the aforesaid sequence.

Each of the one or more chambers (104-1 to 104-3) can be partially filled with filtering elements to filter out a set of contaminants from the exhaust gas received from source 202. The source 202 can be any existing chimney. More particularly, apparatus 100 of the present disclosure can be installed in a currently operating plant without interrupting the operation of the chimney of the plant.

The first chamber 104-1 can be partially filled with a first filtering element 112-1, where the first filtering element 112-1 can include an emulsion of water, oil and detergent. The first chamber 104-1 may include an inlet and an outlet, where an exhaust pipe 108 from the source 202 coupled to the inlet of the first chamber 104-1. The first chamber 104-1 adapted to receive a stream of exhaust gas from source 202 through the exhaust pipe 108. The inlet of the first chamber 104-1 may include perforations to cause the exhaust gas to uniformly spread through the first chamber 104-1. The first chamber 104-1 having a sufficient cross-sectional area and volume to allow enough time for the gas flowing through the first chamber 104-1.

The first chamber 104-1 fluidically coupled to the exhaust pipe 108 of the source 202, the first chamber 104-1 adapted to allow gas from the exhaust pipe 108 of the source to flow through the first filtering element 112-1, where the first filtering element 112-1 is adapted to filter out a first set of contaminants from the gas. The first set of contaminants can include smoke particles. The first filter 106-1 coupled to the outlet of the first chamber 104-1 and adapted to filter the gas received from the first chamber 104-1.

As a result, the exhaust gas which is delivered from the first chamber 104-1 to the second chamber 104-2 is substantially free from smoke particles, however, it still contains harmful gases as pollutants, which can be treated in the second chamber 104-2. The exhaust gas, which has been treated in the first chamber 104-1 is forwarded to the second chamber 104-2.

The second chamber 104-2 can be filled with a second filtering element 112-2 and fluidically coupled to the first filter 106-1 of the first chamber 104-1. The second chamber 104-2 may include an inlet and an outlet, where the inlet of the second chamber 104-2 coupled to the first filter 106-1, the second chamber 104-2 adapted to allow filtered gas from the first filter 106-1 to flow through the second filtering element 112-2. The first filter 106-1 is arranged at a top portion of the first chamber 104-1, where the first filter 106-1 conveys the gases received from the first chamber 104-1 to the bottom portion of the second chamber 104-2. The second filtering element 112-2 is adapted to filter out a second set of contaminants from the gas, where the second filtering element is a detergent mixed with water. The second set of contaminates may include harmful substances present in the gas. The second filter 106-2 coupled to the outlet of the second chamber 104-2 and adapted to filter the gas received from the second chamber 104-2.

A spray gun 110 is coupled to the second chamber 104-2 at the bottom portion of the second chamber 104-2, the spray gun 110 may be operable to produce a mist of detergent and water to the gases from nozzles mounted on the spray gun 110. The second chamber 104-2 may filter the remaining harmful particles from the gas. The output from the second chamber 104-2 is almost completely cleansed, so that the risk of polluting the atmospheric air by the chimney exhaust gas may be eliminated.

The third chamber 104-3 can be filled with a liquid and fluidically coupled to the second filter 106-2 of the second chamber 104-2, where the liquid can be water. The third chamber 104-3 may include an inlet and an outlet. The second filter 106-2 coupled to the inlet of the third chamber 104-3, the third chamber 104-3 adapted to allow filtered gas from the second filter 106-2 to flow through the liquid. The second filter 106-2 is arranged at the top portion of the second chamber 104-2 that conveys the filtered gases from the second chamber 104-2 to the bottom portion of the third chamber 104-3. The third filter 106-3 coupled to the outlet of the third chamber 104-3 and adapted to filter water from the gas received from the third chamber 104-3. Based on the filtration process, the set of contaminants from the gas is removed and converted into clean air that is released to the environment. Accordingly, the risk of air pollution is greatly reduced, by drastically cutting down the amount of harmful exhaust gas released to the atmosphere.

For example, the proposed apparatus 100 can include three chambers, wherein the first chamber 104-1 is filled with diluted detergent mixed water. The exhaust pipe 108 of the chimney is connected to the bottom of the first chamber 104-1 so that polluted gases can pass through the detergent mixed water. Further, the first filter 106-1 is arranged at the top of the first chamber 104-1 that conveys the filtered gases from the first chamber 104-1 to the bottom of the second chamber 104-2. The second chamber 104-2 is filled with gel mixed water and has the second filter 106-2 at its top, which conveys filtered gases from the second chamber 104-2 to the bottom of the third chamber 104-3 and the third chamber 104-3 is filled with water and has a third filter 106-3 at its top, which conveys the final filtered gases to the environment.

The embodiments of the present disclosure described above provide several advantages. The one or more of the embodiments the apparatus 100 that treats polluted gases. The apparatus 100 removes particulate matter and reduces harmful gases from a stream of polluted gases produced by fabrication or combustion processes found in many industries. The present disclosure provides apparatus that is economical, durable in use, and efficient in operation. The apparatus can be available at an affordable cost and can require less maintenance.

FIG. 2 illustrates an exemplary representation 200 of a source coupled to the apparatus, in accordance with an embodiment of the present disclosure.

In an exemplary embodiment, apparatus 100 may be installed adjacent to an existing chimney 202. The apparatus 100 of the present disclosure can be installed in a currently operating plant without interrupting the operation of the chimney of the plant.

The first chamber 104-1 fluidically coupled to the exhaust pipe 108 of the source 202, the first chamber 104-1 adapted to allow gas from the exhaust pipe 108 of the source to flow through the first filtering element 112-1. The second chamber 104-2 can be filled with the second filtering element 112-2 and fluidically coupled to the first filter 106-1 of the first chamber 104-1. The inlet of the second chamber 104-2 coupled to the first filter 106-1, the second chamber 104-2 adapted to allow filtered gas from the first filter 106-1 to flow through the second filtering element 112-2.

The third chamber 104-3 can be filled with the liquid and fluidically coupled to the second filter 106-2 of the second chamber 104-2. The second filter 106-2 coupled to the inlet of the third chamber 104-3, the third chamber 104-3 adapted to allow filtered gas from the second filter 106-2 to flow through the liquid. The set of contaminants from the gas is removed and converted into clean air that is released to the environment through third filter 106-3.

The chemical composition of the exhaust gas from the chimney varies depending on the type of the plant, where carbon dioxide gas and other harmful gases, should be removed before the exhaust gas is released to the outside. With power plants which use heavy oil as fuel, the generation of harmful gas is a problem to be solved. The concentration of the first filtering element 112-1, the second filtering element 112-2 and water 112-3 used in the corresponding chambers (104-1, 104-2), according to the present disclosure, may depend on the concentration of exhaust gas in the chimney.

The apparatus 100 of the disclosure almost completely removes harmful substances, especially carbon-dioxide gas, as well as dust particles from the chimney exhaust, so that clean gas is discharged to the air. The apparatus 100 thus removes particulate matter and reduces harmful gases from a stream of polluted gases produced by fabrication or combustion processes found in many industries. The harmful substance removing apparatus 100 of the present disclosure is highly efficient, economical, stable, and has a long service life.

It will be appreciated by persons skilled in the art that the present invention is not limited by what has been particularly shown and described hereinabove. Rather the scope of the present invention includes both combinations and sub-combinations of various features described hereinabove as well as variations and modifications thereto which would occur to a person of skill in the art upon reading the above description and which are not in the prior art.

While the foregoing describes various embodiments of the invention, other and further embodiments of the invention may be devised without departing from the basic scope thereof. The scope of the invention is determined by the claims that follow. The invention is not limited to the described embodiments, versions or examples, which are included to enable a person having ordinary skill in the art to make and use the invention when combined with information and knowledge available to the person having ordinary skill in the art.

### ADVANTAGES OF THE PRESENT DISCLOSURE

The present disclosure provides an apparatus that treats polluted gases.

The present disclosure provides an apparatus that removes particulate matter and reduces harmful gases from a stream of polluted gases produced by fabrication or combustion processes found in many industries.

The present disclosure provides an apparatus that reduces air pollution.

The present disclosure provides an apparatus that is economical, durable in use, and efficient in operation.

The present disclosure provides an apparatus that is highly efficient, economical, stable, and has a long service life.

The present disclosure provides an apparatus that can be available at an affordable cost and require less maintenance.

We claim:

1. An apparatus (100) for treatment of harmful gas, said apparatus characterized in that comprising:
a first chamber (104-1) partly filled with a first filtering fluid element (112-1) and fluidically coupled to an exhaust pipe (108) of a source, the first chamber (104-1) adapted to allow gas from the exhaust pipe of the source to flow through the first filtering fluid element, wherein the first filtering fluid element (112-1) is adapted to filter out a first set of contaminants from the gas;
a first filter (106-1) coupled to the first chamber (104-1) and adapted to filter the gas received from the first chamber;
a second chamber (104-2) filled with a second filtering fluid element (106-2) and fluidically coupled to the first filter (106-1), the second chamber (104-2) adapted to allow filtered gas from the first filter (106-1) to flow through the second filtering fluid element, wherein the second filtering fluid element is adapted to filter out a second set of contaminants from the gas;
a second filter (106-2) coupled to the second chamber (104-2) and adapted to filter the gas received from the second chamber;
a third chamber (104-3) filled with a liquid and fluidically coupled to the second filter (106-2), the third chamber (104-3) adapted to allow filtered gas from the second filter (106-2) to flow through the liquid; and
a third filter (106-3) coupled to the third chamber (104-3) and adapted to filter the liquid from the gas, wherein based on the filtration process, the set of contaminates from the gas is removed and converted into clean air that is released to the environment.

2. The apparatus as claimed in claim 1, wherein the first filtering fluid element (112-1) is an emulsion of water, oil and detergent.

3. The apparatus as claimed in claim 1, wherein the exhaust pipe (108) of the source (202) is coupled to the bottom of the first chamber (104-1).

4. The apparatus as claimed in claim 1, wherein the first set of contaminants, second set of contaminates comprise any or a combination of smoke particles and harmful substances in the exhaust gas.

5. The apparatus as claimed in claim 1, wherein the first filter (106-1) is arranged at the top portion of the first chamber (106-1), the first filter (106-1) conveys the filtered gases from the first chamber (104-1) to the bottom portion of the second chamber (104-2).

6. The apparatus as claimed in claim 1, wherein the second filtering fluid element (112-1) is a detergent mixed water.

7. The apparatus as claimed in claim 1, wherein the second filter (106-2) is arranged at the top portion of the second chamber (104-2), the second filter (106-2) conveys the filtered gases from the second chamber (104-2) to the bottom portion of the third chamber (104-3).

8. The apparatus as claimed in claim 1, wherein the liquid in the third chamber is water.

9. The apparatus as claimed in claim 1, wherein a spray gun (110) is coupled to the second chamber (104-2), the spray gun (110) operable to produce mist of detergent and water to filter the received gases.

10. The apparatus as claimed in claim 1, wherein the gases comprise carbon dioxide, particulates and any combination thereof.
